(19) United States
(12) Patent Application Publication
(10) Pub. No.: US 2010/0050581 A1
(43) Pub. Date: Mar. 4, 2010

(54) FOLDING FRAME FILTER

(76) Inventor: Daniel E. Schuld, Inverness, IL (US)

Correspondence Address: GREER, BURNS & CRAIN, 300 S WACKER DR, 25TH FLOOR, CHICAGO, IL, 60606, US

(21) Appl. No.: 12/199,314

(22) Filed: Aug. 27, 2008

(51) Int. Cl. B01D 46/00; B31F 1/00

(52) U.S. Cl. 55/503; 493/405

(57) ABSTRACT

A foldable filter having a flexible filter media, a frame surrounding and supporting the filter media, the frame formed of rod members, at least two of which are flexible, each rod member extending between and connecting two corner regions, with the filter media being secured along its edges to the rod members. The filter may be folded by grasping two opposite rod members, rotating the two opposite rod members end over end oppositely relative to one another about a point generally midway along a length of the rod members to effect a relative 180 degree rotation between the two rod members, twisting the filter media, and folding the filter media in half by bringing the two rod members to lie on top of one another.

### BACKGROUND OF THE INVENTION

The invention relates to a filter for use in filtering particulates in a fluid stream, such as in a heating, ventilation and air conditioning system.

Filters for such systems are known, and typically are comprised of a filter media material, such as a polyester or fiberglass pad, which is surrounded by and supported by a rigid frame. The frames may be constructed of cardboard, plastic or metal and in most cases are fixed in size and shape for example to be received in a particular size opening in the ductwork of the heating, ventilation and air conditioning system. The fixed size of these filters dictates the size requirements for shipping containers and storage containers for the filters prior to their use, sometimes requiring very large containers to accommodate large sized filters.

It is known to provide frames for filters that are foldable, such as disclosed in published U.S. Patent Application No. 2008/0034718. It is also known to provide frames for filters or simple screens that are adjustable in size, such as disclosed in U.S. Pat. Nos. Re. 35,236, 3,016,952, 3,805,872, 5,364,458, 5,772,713, 6,007,598, and 6,502,909.

### SUMMARY OF THE INVENTION

A foldable filter is provided having a flexible filter media, a frame surrounding and supporting the filter media, the frame comprising flexible rod members, each extending between and connecting two corner regions, with the filter media being secured along its edges to the rod members. The filter may be folded by grasping two opposite rod members, rotating the two opposite rod members end over end oppositely relative to one another about a point generally midway along a length of the rod members to effect a relative 180 degree rotation between the two rod members, twisting the filter media, and folding the filter media in half by bringing the two rod members to lie on top of one another.

In an embodiment of the invention, the filter frame may be comprised of four rod members.

In an embodiment of the invention, the filter media comprises a plastic material.

In an embodiment of the invention, the filter media comprises a fiberglass material.

In an embodiment of the invention, the rod members are formed integrally as one piece with each other.

In an embodiment of the invention, the frame is generally rectangular.

In an embodiment of the invention, the frame includes corner pieces at each corner region.

In an embodiment of the invention, the corner pieces are formed as right angle corners.

In an embodiment of the invention, the corner pieces are rigid members.

In an embodiment, the rod members are formed separately from one another and are held together by corner pieces.

In an embodiment of the invention, the rod members comprise metal rods.

In an embodiment of the invention, the rod members comprise plastic rods.

In an embodiment of the invention, the rod members comprise rods having circular cross sections.

In an embodiment of the invention, at least two of the rod members are flexible.

A method is provided for folding a foldable filter in which the filter comprises a rectangular shaped flexible filter media, a frame surrounding and supporting the filter media, the frame comprising four rod members, each extending between and connecting two adjacent corner pieces, with the filter media being secured along its edges to the rod members.

The method includes the steps of grasping two opposite rod members, rotating the two opposite rod members end over end oppositely relative to one another about a point generally midway along a length of the rod members to effect a relative 180 degree rotation between the two rod members, twisting the filter media, and folding the filter media in half by bringing the two rod members to lie on top of one another.

In an embodiment, the method includes the step of holding one of the rod members is stationary while the other rod member is rotated 180 degrees.

In an embodiment, the method includes the step of rotating both rod members approximately 90 degrees in opposite directions.

In an embodiment, the method includes the step of folding of the filter media in half after the rod members are rotated relative to one another.

In an embodiment, the method includes the step of folding of the filter media in half while the rod members are rotated relative to one another.

### BRIEF DESCRIPTION OF THE DRAWING

An example of the invention and the method used, and further advantages are detailed below on the basis of the figures.

FIG. 1 is a schematic front elevational view of a filter embodying the present invention.

FIG. 2 is a sectional view of an embodiment of a corner of the filter, taken generally along the line II-II of FIG. 1.

FIG. 3 is schematic front elevational view of an embodiment of the rod frame in isolation.

FIG. 4 is a schematic illustration of the rod members and corner pieces in an exploded view in an alternate embodiment.

FIG. 5 is a sectional view of an embodiment of a rod member taken generally along the line V-V of FIG. 3.

FIG. 6 is a schematic front elevational view of a filter partially folded.

FIG. 7 is a schematic front elevational view of a filter completely folded.

FIG. 8 is a schematic front elevational view of another embodiment of the rod frame in isolation.

FIG. 9 is a schematic front elevational view of the rod frame of FIG. 8 after a first twist step.

FIG. 10 is a schematic front elevational view of the rod frame of FIG. 9 after a folding step.

### DETAILED DESCRIPTION OF THE PREFERRED EMBODIMENTS

An embodiment of a foldable filter 20 is schematically illustrated in FIG. 1 and is comprised of a flexible filter media 22 and a frame 24 surrounding and supporting the filter media. In the embodiment illustrated, the frame 24 has four corner pieces 26. In other embodiments and shapes, the frame may have greater than or fewer than four corner pieces. The filter media 22 is secured at each of the corner pieces. The frame 24 in the embodiment illustrated also includes four flexible rod members 28. Each rod member extends between and connects two of the four corner pieces 26. In other embodiments, the frame 24 may have greater than or fewer than four flexible rod members. The filter media 22 is secured along its edges 30 to the rod members 28.

The filter media 22 may be comprised of a number of different materials, depending on the filtering that is to take place. In the case of air filters, such as those used in heating, ventilation and air conditioning systems, the filter media 22 may be comprised of strands of plastic material, such as polypropylene, or fiberglass. The strands may be overlaid in woven or nonwoven form to provide a flexible mat of material to act as the filter media. The mat should have a flexibility allowing the mat to fold over on itself, and to twist about itself, and, depending again on the filtering that is to take place, should have a thickness generally no greater than about one inch for every 36 inches of length of the length of the rod members 28. The individual strands or fibers of the filter media 22 may be secured in place relative to each other via thermal adhesion or glue or other binders, as is known in the art, such that the mat will present a generally stable mesh of the fibers or strands.

The frame 24 may have a generally rectangular shape, although the sides of the frame need not be completely linear, and the corners of the frame need not be precisely right angles. The frame 24 may also have a general shape other than rectangular, including circulars, L-shaped, or having other geometrical shapes. In an embodiment of the invention as illustrated, the frame 24 is comprised of four sides formed by the rod members 28 in which two of the rod members join one another at each of the four corner pieces 26. The four rod members 28 may be pieces that are separate from one another, and are held relative to one another by the corner pieces 26 as is shown in FIG. 4. Alternatively, the four rod members 28 may be formed as four legs or sides of a single continuous frame member 38 which has four corners 40 as is shown in FIG. 3. The corners 40 of the frame member may be formed as sharp right angles, or they may be rounded as shown in FIG. 3.

The term rod member, as used herein, is meant to mean a length of the frame 24 which extends from one corner piece 26 to the next, either before or after the corner pieces and the rod members are assembled together. The rod members 28 may all be identical throughout the frame 24, or some rod members may be constructed differently than others.

In some embodiments the corner pieces 26 may be permanently secured to the rod members 28 and the filter media 22, and in other embodiments, the corner pieces may be attached after the rod members and filter media are assembled to one another, and may be detachable and replaceable on the assembled rod members and filter media.

The filter media 22 is secured along its edges to the rod members 28. The method of attachment may vary, depending on the composition of the filter media and the rod members 28, but may include thermal attachment, gluing or other binders, stitching, forming a passage in the filter media for the rod members to pass through, etc.

The rod members 28 may comprise individual rods 43 as shown in FIG. 4 or, as mentioned above, the frame 24 may be constructed from a single continuous member in which the rod members may be bent or initially formed at different orientations relative to one another, as shown in FIG. 3. The frame 24 may also be constructed from a single elongated member which is bent into a final shape, and then the two opposite ends, now lying next to one another, are secured to one another, such as by welding. The rod members 28 may be made of metal or plastic materials. As an example, the rod members 28 may be made of spring steel.

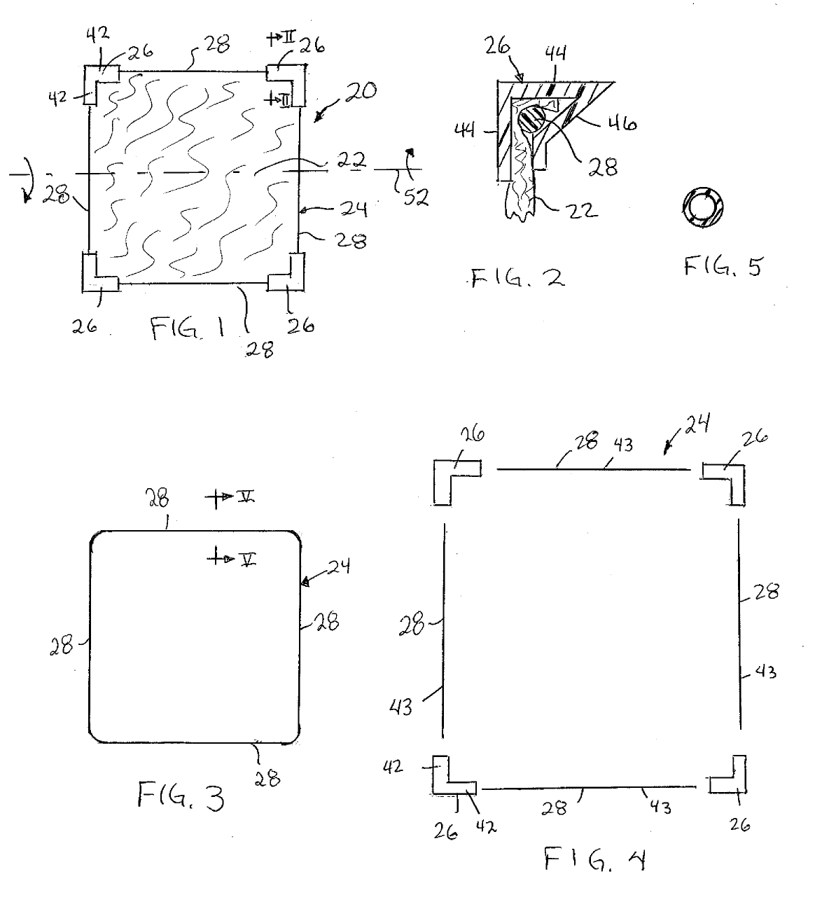

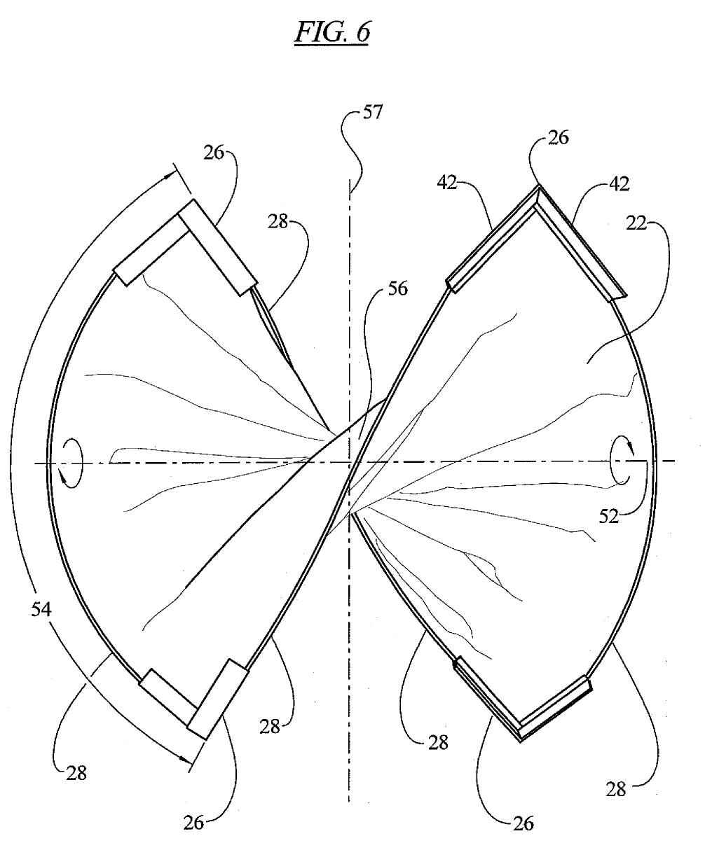

The rod members 28 may have a circular cross section, such as shown in FIG. 5, or they may have other cross sections, such as oval, square, rectangular, triangular, or other shapes, and they may be either solid (FIG. 2) or hollow (FIG. 5).

What is important is that at least some of the rod members 28 must be flexible so that they can bend along their length. The rod members 28 may also be resilient so that they will return to their original orientation, such as linear in the case of a rectangular frame 24, when a flexing force is removed. In other cases, the filter media 22 may provide the resiliency to return the frame 24 to its original shape when the filter 20 is unfolded.

The corner pieces 26 may be formed as right angle corners, with each corner piece having a leg 42 to which one end of one of the rod members 28 is secured. The corner pieces 26 may also be arcuate in shape, extending though a desired angle, such as 90 degrees, or some other angle. The corner pieces 24 may be rigid, so as to retain their original configuration, or they may be somewhat flexible so that the two legs 42 can flex towards and away from one another. The corner pieces 26 may be made of a plastic material, such as polypropylene or nylon, a metal material, such as aluminium, steel, tin or another alloy, or a stiff paper material such as cardboard.

A cross section of the corner piece 26, such as shown in FIG. 2, in an embodiment may have two legs 44 formed generally perpendicular to each other to form an outer part of the corner piece, and at least one additional leg 46 to overlie and secure the rod member 28 and the filter media 22 at the corner piece. The rod members 28 may be fixedly secured at the corner pieces 26 so that there is no relative movement therebetween, other than flexing or bending relative to one another, or the rod members may be secured to the corner pieces in a way that would still permit some relative movement therebetween, such as rotation or sliding to an extent. Many other configurations for the corner pieces 26 may be utilized, so long as the rod members 28 are held at the corner pieces, at least longitudinally relative to the rod members, and so long as the filter media 22 provides a continuous barrier within a central portion of the filter 20, and does not have any gaps or openings along the edges or corners of the frame 24.

In use, the filter 20 is open, such as shown in FIG. 1, presenting a full surface area of the filter media 22 to a fluid stream, such as an air stream, to remove materials from that stream. In order to reduce shipping costs and storage space requirements, the outer perimeter of the filter 20 may be reduced in size by folding.

In an embodiment, the filter 20 may be folded by grasping two opposite flexible rod members 28 generally midway along their length. The two opposite rod members 28 are then rotated end over end oppositely relative to one another about an axis 52 (FIGS. 1 and 6) generally midway along a length 54 of the rod members to effect a relative 180 degree rotation between the two rod members. This 180 degree rotation will result in a twisting of the filter media at 56 as shown in FIG. 6. The corner pieces 26 will remain relatively fixed with their legs 42 at right angles, while the rod members 28 will each flex into an arcuate shape with the filter media 22 twisted upon itself Then the filter media 22 is folded in half generally along an axis 56 passing through a center of the twist which is perpendicular to the axis 52 about which the rod members 28 were rotated. As the filter media 22 is folded, the two opposite rod members 28 are caused to generally lie on top of one another, as are the two connecting rod members. Each of the rod members 28 retain an arcuate shape when the filter 20 is folded.

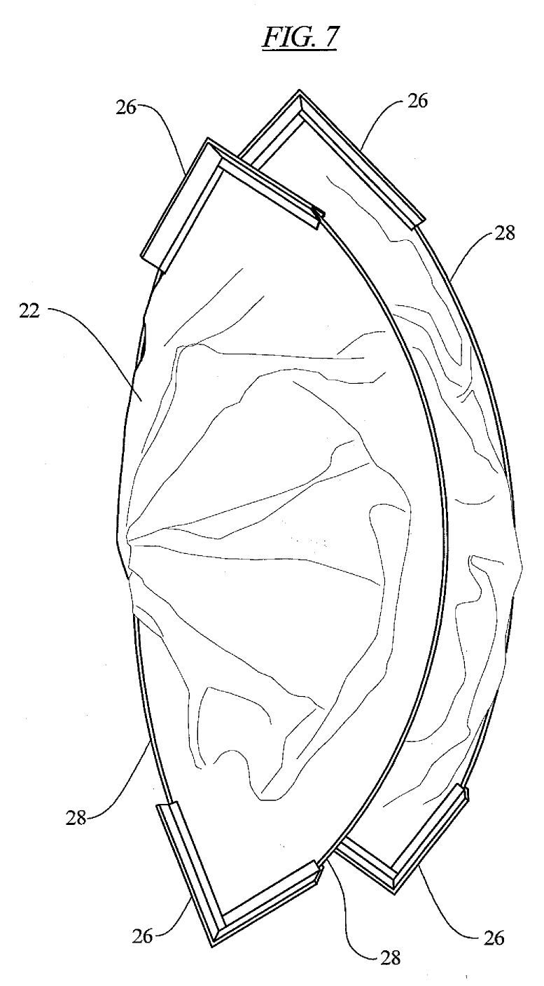

FIGS. 7-9 illustrate another embodiment of a rod frame 24A which has a generally rectangular shape. This rod frame is comprised of four rod members 28A, 28B which are connected to adjacent rod members at corner regions 26A. In this embodiment, the corner regions 26A are formed from the same material as the rod members, such that the rod frame 24A is formed as a unitary member. In other embodiments, the rod frame may have separate corner pieces, as illustrated in FIGS. 1-6.

With the embodiment of FIGS. 7-9, the flexible filter media is to be secured along its edges to the rod members 28A, 28B. The filter may be comprised of only the filter media and the rod frame, without separate corner pieces, or corner pieces, such as illustrated in FIGS. 1-6 may be used. If the filter does not use separate corner pieces, the thickness of the filter media will provide the necessary seal of the filter in the ductwork where the filter is utilized.

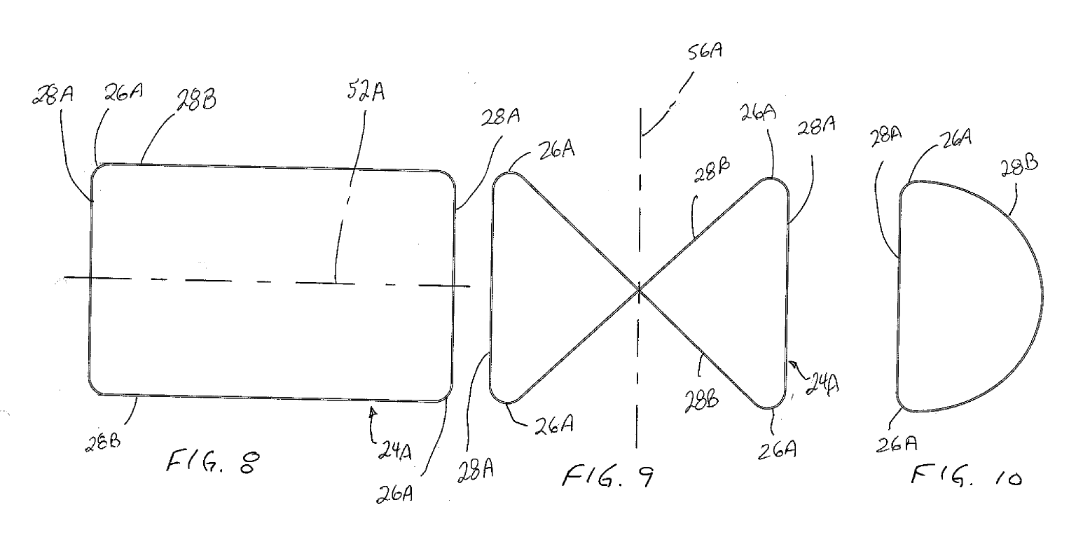

FIG. 8 illustrates the rod frame 24A after a first, twisting step, as described above with respect to FIGS. 1 and 6 has occurred. That is, the two opposite rod members 28A that are shorter are grasped and rotated about an axis 52A by 180 degrees relative to one another, twisting the frame 24A (and the filter media 22 that would be attached to the frame).

FIG. 9 illustrates the rod frame 24A after a second, folding step, as described above with respect to FIGS. 6 and 7 has occurred. That is, the frame 24A is folded along an axis 56A (folding the filter media 22 that would be attached to the frame), which causes the longer rod members 28B to flex and bend. The shorter rod members 26A remain generally linear, and so would not necessarily have to be flexible like the longer rod members would.

In all other respects, the embodiment illustrated in FIGS. 7-9 could be modified as in the embodiments illustrated in FIGS. 1-6, such as by optionally including corner pieces, and varying the thickness and attachment methods for the filter media.

While only certain embodiments have been set forth, alternative embodiments and various modifications will be apparent from the above description to those skilled in the art. These and other alternatives are considered equivalents and within the spirit of scope of the present invention. It should be understood that I wish to embody within the scope of the patent warranted heron all such modifications as reasonably and properly come within the scope of my contribution to the art.

1. A foldable filter comprising:
a flexible filter media,
a frame surrounding and supporting the filter media,
the frame comprising corner pieces and flexible rod members, each rod member extending between and connecting two adjacent corner pieces, with the filter media being secured along its edges to the rod members.

2. The foldable filter of claim 1, wherein the frame is generally rectangular.

3. The foldable filter of claim 1, wherein the frame comprises four corner pieces connected by four flexible rod members.

4. The foldable filter of claim 1, wherein the flexible rod members are integrally joined to one another as a single frame member.

5. The foldable filter of claim 1, wherein the flexible rod members comprise separate rod elements connected by the corner pieces to form the frame.

6. The foldable filter of claim 1, wherein the corner pieces are rigid members.

7. The foldable filter of claim 1, wherein the rod members comprise metal rods.

8. The foldable filter of claim 1, wherein the rod members comprise plastic rods.

9. The foldable filter of claim 1, wherein the rod members comprise rods having circular cross sections.

10. A method for folding a foldable filter in which the filter comprises a flexible filter media, a frame surrounding and supporting the filter media, the frame comprising corner pieces and flexible rod members, each flexible rod member extending between and connecting two adjacent corner pieces, with the filter media being secured along its edges to the rod members, the method comprising:
grasping two opposite flexible rod members,
rotating the two opposite rod members end over end oppositely relative to one another about a point generally midway along a length of the rod members to effect a relative 180 degree rotation between the two rod members, twisting the filter media, and
folding the filter media in half by bringing the two rod members to lie on top of one another.

11. The method of claim 10, wherein one of the rod members is held stationary while the other rod member is rotated 180 degrees.

12. The method of claim 10, wherein both rod members are rotated approximately 90 degrees in opposite directions.

13. The method of claim 10, wherein the folding of the filter media in half occurs after the rod members are rotated relative to one another.

14. The method of claim 10, wherein the folding of the filter media in half occurs while the rod members are rotated relative to one another.

15. A foldable filter comprising:
a flexible filter media,
a frame surrounding and supporting the filter media, the frame having a generally rectangular shape with sides formed by rod members which are connected to adjacent rod members at corner regions, at least two of the rod members being flexible, with the filter media being secured along its edges to the rod members.

16. The foldable filter of claim 15, wherein the corner regions comprise separate corner pieces, each engaged by two rod members.

17. The foldable filter of claim 16, wherein the corner pieces are formed as right angle corners.

18. The foldable filter of claim 16, wherein the corner pieces are rigid members.

19. The foldable filter of claim 15, wherein the rod members are integrally joined to one another as a single frame member.

20. The foldable filter of claim 15, wherein all of the rod members are flexible.
